(19) United States
(12) Patent Application Publication
(10) Pub. No.: US 2024/0270608 A1
(43) Pub. Date: Aug. 15, 2024

(54) WATER FILTRATION ASSEMBLY WITH ENHANCED CONTAMINANT REDUCTION PERFORMANCE

(71) Applicant: Haier US Appliance Solutions, Inc., Wilmington, DE (US)

(72) Inventors: Gregory Sergeevich Chernov, Louisville, KY (US); Amin Firouzi, Louisville, KY (US)

(21) Appl. No.: 18/168,913

(22) Filed: Feb. 14, 2023

(51) Int. Cl. C02F 1/32; C02F 1/00; C02F 1/28; C02F 1/42; C02F 1/44

(52) U.S. Cl. CPC C02F 1/325; C02F 1/003; C02F 1/281; C02F 1/283; C02F 1/42; C02F 1/44; C02F 2201/3222; C02F 2201/3228; C02F 2201/328; C02F 2303/04; C02F 2307/10; C02F 2307/12; F25D 2323/121

(57) ABSTRACT

A water filtration assembly for an appliance is disclosed having a filtration housing, a filtration media block positioned within the filtration housing, and an electromagnetic radiation module having an electromagnetic radiation source positioned within the filtration housing. The electromagnetic radiation source is positioned adjacent to the filtration media block. Further, the filtration media block has a hollow cylindrical configuration defining a radiation passageway. As such, water is configured to enter a water inlet of the filtration housing, travel through one or more walls of the filtration media block for treatment and into the radiation passageway for further treatment by the electromagnetic radiation source, and exit a water outlet of the filtration housing.

### FIELD OF THE INVENTION

The present subject matter relates generally to water filtration assemblies, and more particularly to water filtration assemblies having enhanced contaminant reduction performance.

### BACKGROUND OF THE INVENTION

Fresh water is a limited resource on the earth. Water shortage and contamination are among the top current issues in public health. With an increase in drinking water contaminant levels and the emergence of new contaminants, improvements in chemical and microbiological reduction performance of end point water treatment systems are desired to ensure consumer protection from potentially harmful exposure.

Water treatment using adsorptive media has been in practice since ancient times. Although, modern Activated Carbon-based (AC) technologies allow the reduction of multiple health-related contaminants, the further significant improvement of contaminant reduction performance is challenging. In most cases, an improvement of contaminant reduction performance requires an increase of physical dimensions of the product (a limiting factor for many residential applications), and/or a reduction of effective pore size (pore size reduction demands higher feed pressures or lowers flow rates which are also limiting factors for most residential applications). For most AC-based systems, the microbiological reduction is limited to relatively large protozoa and most of these systems provide no protection from harmful bacteria and viruses.

Water treatment using germicidal ultraviolet (UV) radiation has also been practiced for several decades. Although UV treatment can provide significant levels of microbiological reduction, it has several disadvantages. For example, UV treatment requires direct line of sight, and to be effective, the treated water must be optically clear and contain no particulates. UV provides some levels of reduction for additional contaminants, but these levels are inferior to the reduction level granted by many alternative water treatment methods.

Systems combining AC modules and ultraviolet-C (UVC) modules exist in the market as well. Although these systems combine the benefits and mitigate the disadvantages of both technologies used separately, they are mechanically complex, have a large footprint, and often require multiple replaceable consumables. As such, the excessive complexity and space limitations restrict an integration of these combined systems into most household appliances where the space is limited, and the cost is a critical factor. Moreover, systems with multiple consumable elements impose a greater burden on the end consumer.

Accordingly, there is a continuous need for a water filtration assembly having enhanced contaminant reduction performance to address the aforementioned issues.

### BRIEF DESCRIPTION OF THE INVENTION

Aspects and advantages of the invention will be set forth in part in the following description, or may be obvious from the description, or may be learned through practice of the invention.

In an aspect, the present disclosure is directed to a water filtration assembly for an appliance. The water filtration assembly includes a filtration housing and a filtration media block positioned within the filtration housing. The filtration media block has a hollow cylindrical configuration defining a radiation passageway. The water filtration assembly also includes an electromagnetic radiation module positioned within the filtration housing and having an electromagnetic radiation source positioned adjacent to the filtration media block. As such, water is configured to enter a water inlet of the filtration housing, travel through one or more walls of the filtration media block for treatment and into the radiation passageway for further treatment by the electromagnetic radiation source, and exit a water outlet of the filtration housing.

In another aspect, the present disclosure is directed to a method of treating water using a water filtration assembly. The method includes positioning a filtration media block in a first region of the water filtration assembly within a filtration housing. The filtration media block has a hollow cylindrical configuration defining a radiation passageway. The method also includes positioning an electromagnetic radiation module having an electromagnetic radiation source in a second region of the water filtration assembly. The second region is fluidly isolated from the first region. The electromagnetic radiation source is positioned adjacent to the filtration media block. The method also includes providing the water to a water inlet of the filtration housing and filtrating the water through one or more walls of the filtration media block for initial treatment and subsequently into the radiation passageway for further treatment by the electromagnetic radiation source, wherein the water then exits a water outlet of the filtration housing.

These and other features, aspects and advantages of the present disclosure will become better understood with reference to the following description and appended claims. The accompanying drawings, which are incorporated in and constitute a part of this specification, illustrate embodiments of the present disclosure and, together with the description, serve to explain the principles of the present disclosure.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 illustrates a front view of an embodiment of an appliance according to the present disclosure;

FIG. 2 illustrates a perspective view of the appliance shown in FIG. 1;

FIG. 3 illustrates a front view of the refrigerator appliance shown in FIG. 1 with doors in an open position;

FIG. 4 illustrates a simplified side view of an embodiment of a water filtration assembly secured within an appliance according to the present disclosure;

FIG. 5 illustrates a simplified internal view of an embodiment of a water filtration assembly according to the present disclosure;

FIG. 6 illustrates a simplified internal view of another embodiment of a water filtration assembly according to the present disclosure;

FIG. 7 illustrates a simplified internal view of another embodiment of a water filtration assembly according to the present disclosure;

FIG. 8 illustrates a simplified internal view of still another embodiment of a water filtration assembly according to the present disclosure;

FIG. 9 illustrates a simplified internal view of yet another embodiment of a water filtration assembly according to the present disclosure;

FIG. 10 illustrates a simplified internal view of another embodiment of a water filtration assembly according to the present disclosure; and

FIG. 11 illustrates a flow diagram of an embodiment of a method for treating water using a water filtration assembly according to the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

Generally, the present disclosure is directed to water filtration assemblies, and more particularly to water filtration assemblies having enhanced contaminant reduction performance. In particular, in certain embodiments, the water filtration assemblies of the present disclosure include a filtration housing for enclosing a filtration media block and an electromagnetic radiation module having an electromagnetic radiation source, although the disclosure is not limited to such configurations.

More specifically, in an embodiment according to the present disclosure, the filtration media block may have a hollow cylindrical configuration (or any other shape or structure) defining a radiation passageway. Thus, in an embodiment, the electromagnetic radiation source may be positioned adjacent to the filtration media block. In this way, the filtration housing may be configured such that water enters a water inlet, travels through one or more walls of the filtration media block into the radiation passageway, and is treated (e.g., irradiated) by the electromagnetic radiation source prior to exiting a water outlet of the filtration housing.

In an embodiment, the filtration media block described herein may be constructed of any suitable material, such as activated carbon (AC). In such embodiments, the adsorptive, catalytic, and structural properties of AC make it effective at capturing contaminants including particulates, volatile organic compounds (VOCs), metals, pharmaceuticals, pharmaceutical break-down products, per- and polyfluoroalkyl substances (PFASs), disinfectants, disinfectant by-products, and other contaminants. In another embodiment, the filtration media block may be constructed of a zeolite, a non-woven material, a textile, an immobilized granulated media, an ion exchange resin, a membrane, a hollow fiber, and/or a composite of natural or synthetic materials.

In another embodiment according to the present disclosure, the filtration housing may be installed within an appliance. The filtration housing may thus, in an embodiment, include a first end for securing to a wall of the appliance and a second end for receiving the filtration media block, the electromagnetic radiation module, and any other component, structure, or feature of the filtration housing. In this way, the first end of the filtration housing may be secured, for example, to a manifold positioned on the wall of the appliance to allow the inlet and the outlet of the filtration housing to engage with a corresponding feature on the manifold.

Moreover, in another embodiment, a lens may be arranged adjacent to the filtration media block such that electromagnetic radiation emitted by the electromagnetic radiation emitter can pass through the lens before irradiating the radiation passageway. In another embodiment, a reflective sleeve constructed of, for example, polytetrafluoroethylene (PTFE) and/or aluminum, may be positioned within the radiation passageway.

Moreover, the present disclosure is also directed to a method of assembling a water filtration assembly. In an embodiment, for example, the method includes positioning a filtration media block in a first region of the water filtration assembly within a filtration housing, the filtration media block having a hollow cylindrical configuration defining a radiation passageway. The method also includes positioning an electromagnetic radiation module having an electromagnetic radiation source in a second region of the water filtration assembly, the second region being fluidly isolated from the first region. Further, the electromagnetic radiation source is positioned adjacent to the filtration media block. Moreover, the method includes providing the water to a water inlet of the filtration housing and filtrating the water through one or more walls of the filtration media block for initial treatment and subsequently into the radiation passageway for further treatment by the electromagnetic radiation source, wherein the water then exits a water outlet of the filtration housing.

As such, the present disclosure provides many advantages not present in the prior art. For example, the water filtration assembly of the present disclosure allows for a compact design having a high surface-area, solid, porous filtration media (e.g., AC) along with one or more high-energy, short-wavelength electromagnetic radiation sources that can produce germicidal radiation (e.g., UV light) to cause irreversible damage to biological contaminants. Further, the water filtration assembly may be used in various household appliances including refrigerators, icemakers, dishwashers, water purifiers, beverage systems, washing machines, etc., as well as any other appliance that may benefit from filtered water.

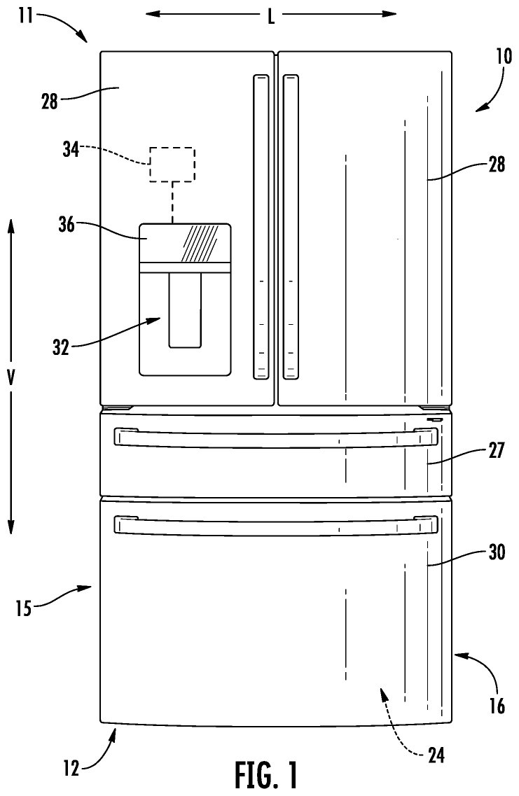

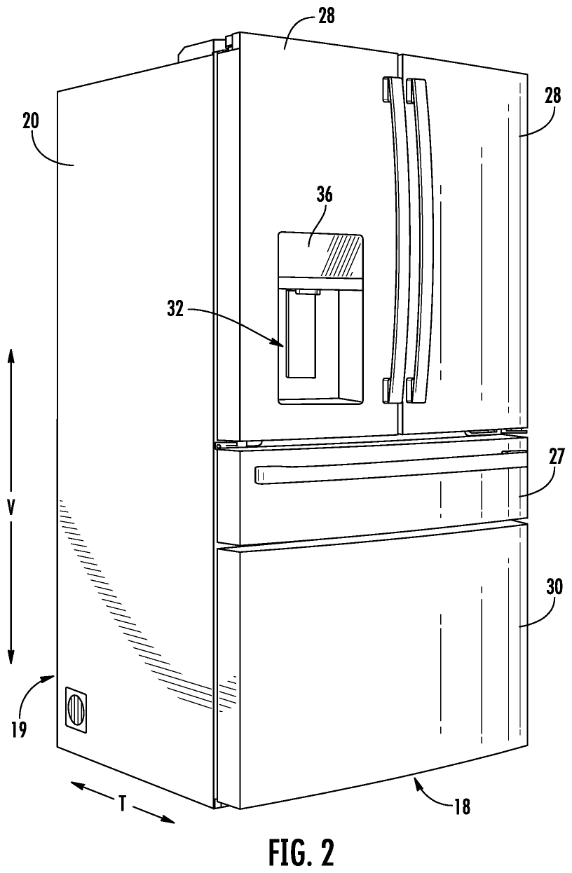

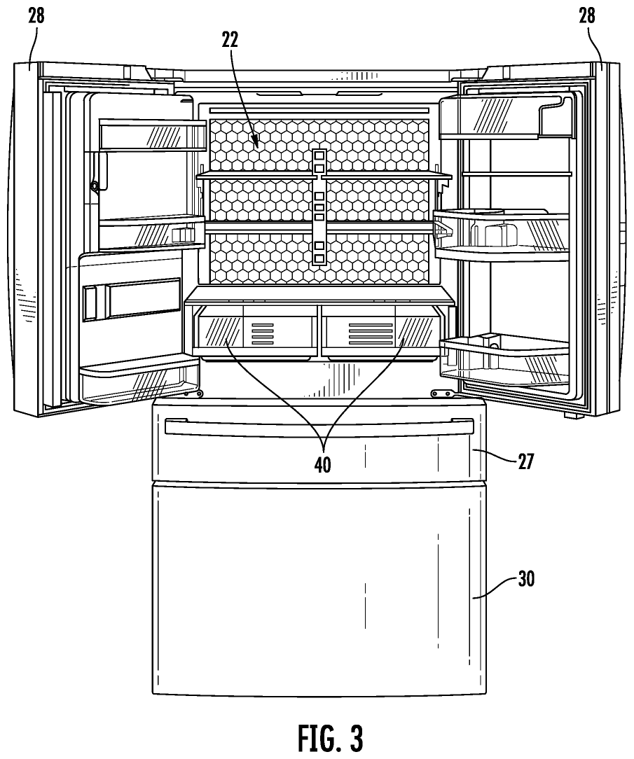

Referring now to the drawings, FIG. 1 illustrates a front view of an embodiment of a refrigerator appliance 10 according to the present disclosure. FIG. 2 illustrates a perspective view of the refrigerator appliance 10. FIG. 3 illustrates a front view of the refrigerator appliance 10 with refrigerator doors 28 in an open position. FIG. 1, in particular, illustrates the refrigerator appliance 10 extending between a top 11 and a bottom 12 along a vertical direction V. The refrigerator appliance 10 also extends between a first side 15 and a second side 16 along a lateral direction L. As shown in FIG. 2, a transverse direction T may additionally be defined perpendicular to the vertical and lateral directions V, L. The refrigerator appliance 10 extends along the transverse direction T between a front portion 18 and a back portion 19.

The refrigerator appliance 10 may include a cabinet or housing 20 (FIG. 2) defining an upper fresh food chamber 22 (FIG. 3) and a lower freezer storage chamber 24 arranged below the upper fresh food chamber 22 along the vertical direction V. An auxiliary food storage chamber may be positioned between the upper fresh food chamber 22 and the lower freezer storage chamber 24, e.g., along the vertical direction V. Because the lower freezer storage chamber 24 is positioned below the upper fresh food chamber 22, the refrigerator appliance 10 may be generally referred to as a bottom mount refrigerator. In the embodiment, the housing 20 may also define a mechanical compartment (not shown) for receipt of a sealed cooling system (not shown). Using the teachings disclosed herein, one of ordinary skill in the art will understand that the present technology can be used with other types of refrigerators (e.g., side-by-side) or a freezer appliance as well. Consequently, the description set forth herein is for illustrative purposes only and is not intended to limit the technology in any aspect.

Referring now particularly to FIG. 3, the refrigerator doors 28 may each be rotatably hinged to an edge of the housing 20 for accessing the upper fresh food chamber 22. It should be noted that while two refrigerator doors 28 in a “French door” configuration are illustrated, any suitable arrangement of doors utilizing one, two or more doors is within the scope and spirit of the present disclosure. A freezer door 30 may be arranged below the refrigerator doors 28 for accessing the lower freezer storage chamber 24. In the embodiment, the freezer door 30 is coupled to a freezer drawer (not shown) slidably mounted within the lower freezer storage chamber 24. An auxiliary door 27 may be coupled to an auxiliary drawer which may be slidably mounted within the auxiliary chamber.

Referring back to FIG. 1, operation of the refrigerator appliance 10 can be regulated by a controller 34 that is operatively coupled to a user interface panel 36. The user interface panel 36 may provide selections for user manipulation of the operation of the refrigerator appliance 10 to modify environmental conditions therein, such as temperature selections, etc. In some embodiments, the user interface panel 36 is proximate a dispenser assembly 32. In response to user manipulation of the user interface panel 36, the controller 34 may operate various components of the refrigerator appliance 10. Operation of the refrigerator appliance 10 may be regulated by the controller 34, e.g., the controller 34 may regulate operation of various components of the refrigerator appliance 10 in response to programming and/or user manipulation of the user interface panel 36.

The controller 34 may include a memory and one or more microprocessors, CPUs or the like, such as general or special purpose microprocessors operable to execute programming instructions or micro-control code associated with operation of the refrigerator appliance 10. The memory may represent random access memory such as DRAM, or read only memory such as ROM or FLASH. In one embodiment, the processor executes programming instructions stored in memory. The memory may be a separate component from the processor or may be included onboard within the processor. It should be noted that controller(s) 34 as disclosed herein are capable of and may be operable to perform any methods and associated method steps as disclosed herein.

The controller 34 may be positioned in a variety of locations throughout the refrigerator appliance 10. In the illustrated embodiment, the controller 34 is located within the refrigerator doors 28. In such an embodiment, input/output (“I/O”) signals may be routed between the controller and various operational components of the refrigerator appliance 10. In one embodiment, the user interface panel 36 represents a general purpose I/O (“GPIO”) device or functional block. In one embodiment, the user interface panel 36 includes input components, such as one or more of a variety of electrical, mechanical or electro-mechanical input devices including rotary dials, push buttons, and touch pads. The user interface panel 36 may include a display component, such as a digital or analog display device designed to provide operational feedback to a user. For example, the user interface panel 36 may include a touchscreen providing both input and display functionality. The user interface panel 36 may be in communication with the controller via one or more signal lines or shared communication busses.

Using the teachings disclosed herein, one of skill in the art will understand that the present disclosure can be used with other types of refrigerators such as a refrigerator/freezer combination, side-by-side, bottom mount, compact, and any other style or model of refrigerator appliance. Accordingly, other configurations of the refrigerator appliance 10 could be provided, it being understood that the configurations shown in the accompanying figures and the description set forth herein are by way of example for illustrative purposes only.

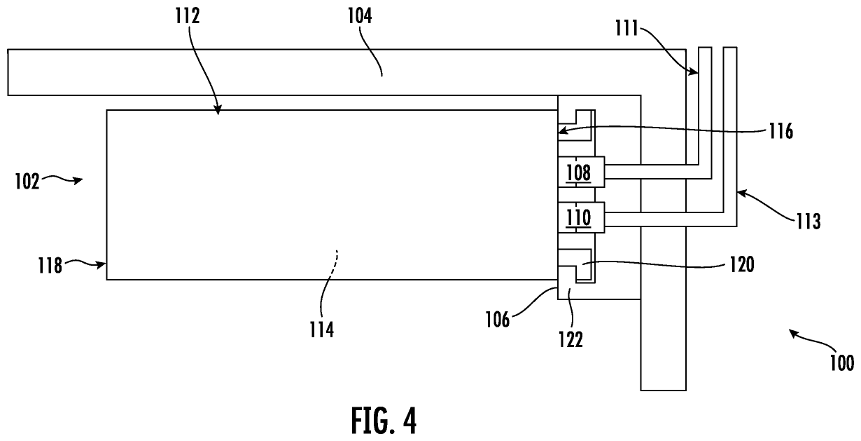

Referring now to FIG. 4, a simplified side view of an embodiment of an appliance 100 having a water filtration assembly 102 according to the present disclosure is illustrated. In particular, as shown, the appliance 100 includes at least one wall 104 having a manifold 106 secured thereto. Furthermore, as shown, the appliance 100 generally includes a water source (not shown) that provides water to and from the water filtration assembly 102, e.g., through the manifold 106 via a water inlet 108 and a water outlet 110. In addition, as shown, the appliance 100 may include supply and return tubes 111, 113 fluidly coupled to the water inlet and water outlet 108, 110, respectively.

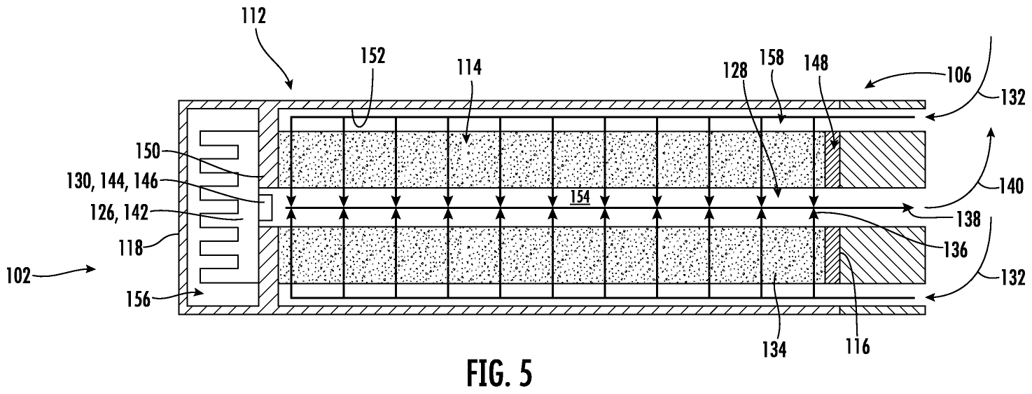

Referring to FIGS. 4 and 5, the water filtration assembly 102 includes a filtration housing 112 and a filtration media block 114 in fluid communication with the water inlet 108 and the water outlet 110. More specifically, in the illustrated embodiment, the filtration housing 112 includes a first end 116 for securing the water filtration assembly 102 to the manifold 106 and a second end 118 for receiving at least a portion of the components/structures of the water filtration assembly 102. In particular embodiments, as shown in FIG. 4, the first end 116 of the filtration housing 112 may include one or more interlocking features 120 configured to secure the water filtration assembly 102 to corresponding interlocking features 122 of the manifold 106 positioned on the wall 104 of the appliance 100. In further embodiments, the first end 116 of the filtration housing 112 may be secured to the manifold 106 using any suitable means. Furthermore, as shown generally in FIG. 5, the filtration media block 114 may generally have a hollow cylindrical configuration defining a radiation passageway 128.

Referring particularly to FIG. 5, the water filtration assembly 102 further includes an electromagnetic radiation module 126. Moreover, as shown, the electromagnetic radiation module 126 includes an electromagnetic radiation source 130 positioned adjacent to the filtration media block 114. As such, in an embodiment, water (as represented by arrows 132 in FIG. 5) is configured to enter the water filtration assembly 102 via the water inlet 108, travel through one or more walls 134 of the filtration media block 114 for treatment (as represented by arrows 136) and into the radiation passageway 128 for further treatment by the electromagnetic radiation (as represented by arrow 138) emitted by the electromagnetic radiation source 130, and exit the water outlet 110 (as represented by arrows 140).

In an embodiment, the filtration media block 114 described herein may be constructed of any suitable material, such as activated carbon (AC). In such embodiments, the adsorptive, catalytic, and structural properties of AC make it effective at capturing contaminants including particulates, volatile organic compounds (VOCs), metals, pharmaceuticals, pharmaceutical break-down products, per- and polyfluoroalkyl substances (PFASs), disinfectants, disinfectant by-products, and other contaminants. In another embodiment, the filtration media block 114 may be constructed of a zeolite, a non-woven material, a textile, an immobilized granulated media, an ion exchange resin, a membrane, a hollow fiber, and/or a composite of natural or synthetic materials.

In another embodiment, the electromagnetic radiation module 126 may be a UVC module 142 and the electromagnetic radiation source 130 may be an electromagnetic radiation emitter 144 that emits germicidal radiation via an ultraviolet-C (UVC) emitting diode. Thus, in such embodiments, as shown in FIG. 5, the electromagnetic radiation emitter 144 may be a UVC emitting diode 146. In further embodiments, the electromagnetic radiation source 130 may be a blue light emitting diode (LED), an ultraviolet-A (UVA) emitting diode, an ultraviolet-B (UVB) emitting diode, or similar.

Still referring to FIG. 5, the water filtration assembly 102 may include a first end cap 148 adjacent to the filtration media block 114 and a second end cap 150 adjacent to the electromagnetic radiation module 126. In particular, as shown, the second end cap 150 may extend from an inner surface 152 of the filtration housing 112 to divide an inner volume 154 of the filtration housing 112 into a first region 156 and a second region 158.

In such embodiments, as shown, the electromagnetic radiation module 126 (e.g., the UVC module 142) is situated at least partially within the first region 156, whereas the filtration media block 114 is situated within the second region 158. Moreover, in an embodiment, as shown, the electromagnetic radiation source 130 may be positioned at least partially through the second end cap 150. Accordingly, water enters the water filtration assembly 102 through the manifold 106. As the water travels through the wall 134 of the filtration media block 114, the water goes through a first level of purification. Then, as the water travels through the radiation passageway 128, the water goes through a second level of purification.

In another embodiment, one or more additional electronic components may be housed (e.g., positioned) within the first region 156. Thus, the one or more electronic components may be fluidly isolated from the second region 158 of the filtration media block 114, and thus fluidly isolated from the flow of water received within the second region 158. In another embodiment, the first region 156 may be selectively accessible (e.g., by a user) (not shown) and, for example, a liquid tight access door may be provided on the filtration housing 112 providing access to the first region 156 when the water filtration assembly 102 is fully assembled. In another embodiment, the first region 156 may be sealed with respect to each of the second region 158 and the surrounding atmosphere when the water filtration assembly 102 is fully assembled.

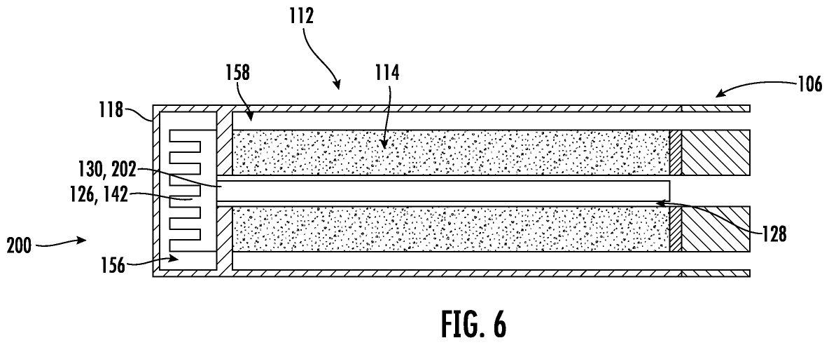

Referring now to FIG. 6, a simplified internal view of another embodiment of a water filtration assembly 200 according to the present disclosure is illustrated. In particular, the water filtration assembly 200 is similar to the water filtration assembly 102 shown in FIG. 5 and thus, like components will have the same numbering. In particular, similar to FIGS. 4 and 5, the water filtration assembly 200 of FIG. 6 includes the filtration housing 112 and the filtration media block 114 having the water inlet 108 and the water outlet 110 (as shown in FIG. 4) Further, as shown, the filtration media block 114 defines the radiation passageway 128. In addition, the water filtration assembly 200 includes the electromagnetic radiation module 126 being the UVC module 142 and the electromagnetic radiation source 130. However, in contrast to the embodiment of FIG. 5, the electromagnetic radiation source 130 includes a UVC bulb 202 rather than the UVC emitting diode 146.

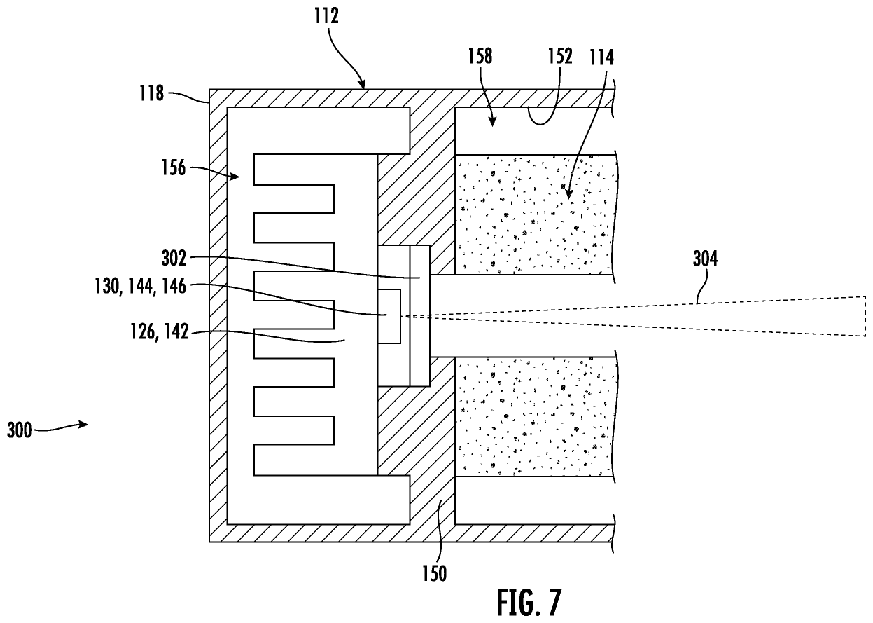

Referring now to FIG. 7, a simplified internal view of still another embodiment of a water filtration assembly 300 according to the present disclosure is illustrated. In particular, the water filtration assembly 300 is similar to the water filtration assembly 102 shown in FIG. 5 and thus, like components will have the same numbering. Furthermore, as shown in the embodiment of FIG. 7, the water filtration assembly 300 may also include a lens 302 arranged adjacent to the electromagnetic radiation emitter 144 (i.e., the UVC emitting diode 146) such that the emitted radiation passes through the lens 302 before irradiating the radiation passageway 128. In an embodiment, for example, the lens 302 may be made of borosilicate glass or another suitable material transparent to the wavelength of the electromagnetic radiation from the emitter 144. In this way, the lens 302 is configured to isolate the first region 156, which is dry, from the second region 158, which is wet. In some embodiments, the lens 302 can be designed to modify the direction of the electromagnetic radiation rays. For example, in an embodiment, and as shown in FIG. 7, the lens 302 is configured to reduce the rays into a narrow beam 304 and, consequently increase the radiation intensity within the passageway 128.

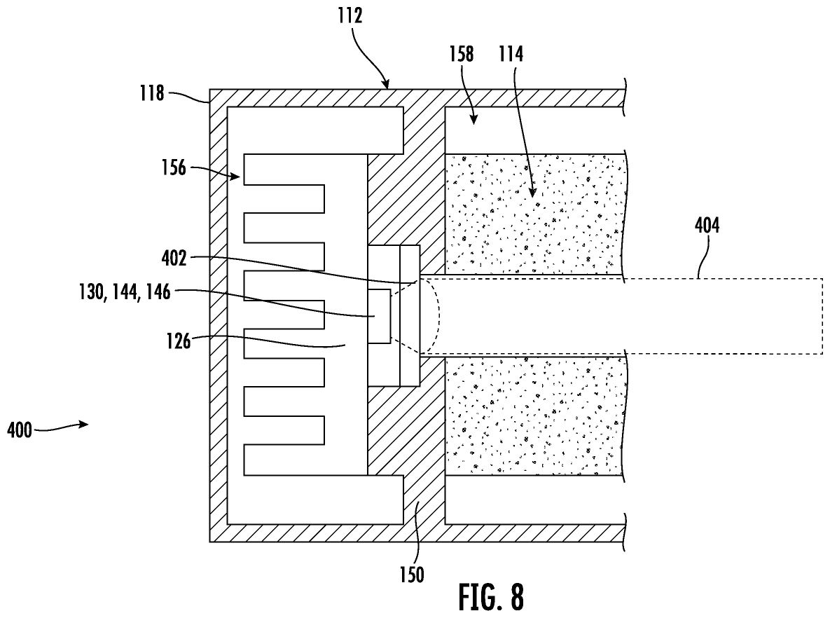

Referring now to FIG. 8, a simplified internal view of yet another embodiment of a water filtration assembly 400 according to the present disclosure is illustrated. In particular, the water filtration assembly 400 is similar to the water filtration assembly 102 shown in FIG. 5 and thus, like components will have the same numbering. Furthermore, as shown in the embodiment of FIG. 8, the water filtration assembly 400 may further include a collimating lens 402 arranged adjacent to the electromagnetic radiation emitter 144 such that the emitted radiation light can pass through the collimating lens 402 before irradiating the radiation passageway 128. In this way, the collimating lens 402 is configured to provide a radiation beam 404 with a nearly constant correction into the radiation passageway 128 so as to improve consistency and efficiency of microbial deactivation.

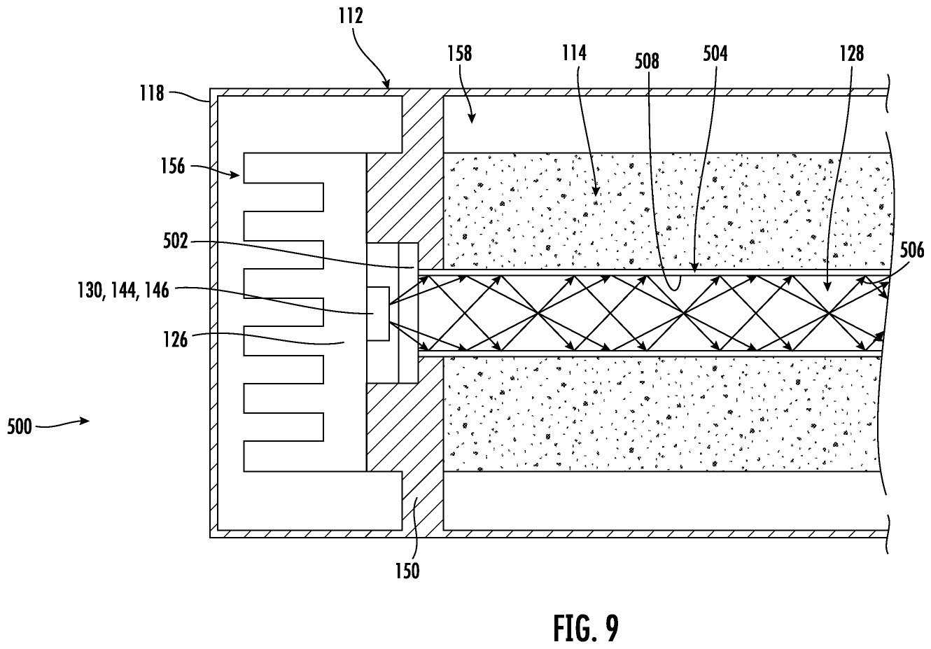

Referring now to FIG. 9, a simplified internal view of another embodiment of a water filtration assembly 500 according to the present disclosure is illustrated. In particular, the water filtration assembly 500 is similar to the water filtration assembly 400 shown in FIG. 5 and thus, like components will have the same numbering. Furthermore, as shown in the embodiment of FIG. 9, the water filtration assembly 500 further includes a lens 502 and a reflective sleeve 504 positioned within the radiation passageway 128. In such embodiments, the reflective sleeve 504 may be constructed of one or more material(s) with high reflectively with respect to the wavelength of the radiation emitted by the source electromagnetic radiation 130. For example, if the electromagnetic radiation source 130 is configured to emit radiation in UVC spectrum, the reflective sleeve 504 may be constructed from PTFE, aluminum, or any other material reflective to UVC radiation can be used. so as to improve consistency and efficiency of microbial deactivation.

In such embodiments, without the reflective sleeve 504, once radiation rays 506 reach the walls of the radiation passageway 128, the radiation rays 506 would be either absorbed or scattered by the wall material and the germicidal energy of these rays is lost or diminished significantly. In contrast, with the reflective sleeve 504, once the radiation rays 506 reach the reflective walls 508, the radiation rays 506 are redirected back towards a center of the radiation passageway 128 and at least a part of the germicidal energy of the radiation rays 506 becomes available for the water treatment. In certain embodiments, a sleeve material with greater reflectivity to the wavelength of the radiation rays 506 results in greater amount of saved radiation energy. In further embodiments, it should be understood that the reflective sleeve 504 may also be used without the lens 502.

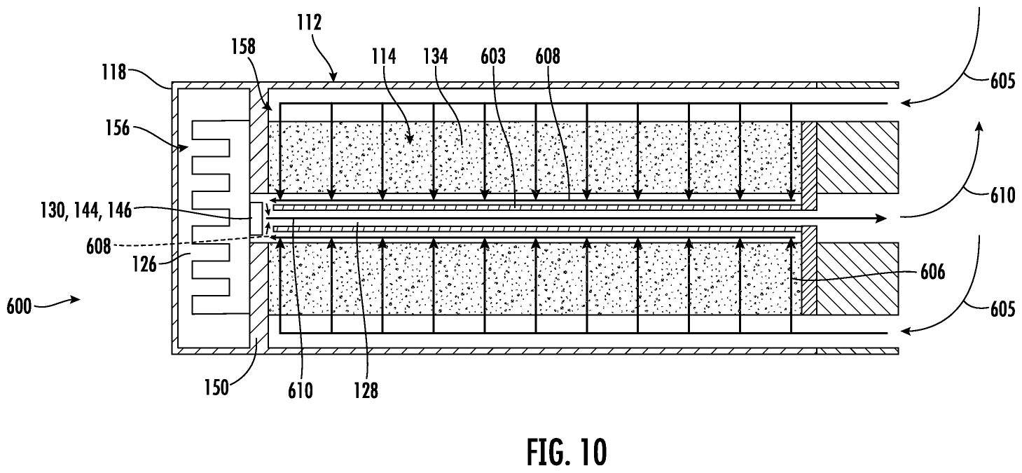

Referring now to FIG. 10, a simplified internal view of yet another embodiment of a water filtration assembly 600 according to the present disclosure is illustrated. In particular, the water filtration assembly 600 is similar to the water filtration assembly 102 shown in FIG. 5 and thus, like components will have the same numbering. Furthermore, as shown in the embodiment of FIG. 10, the water filtration assembly 600 includes one or more flow barriers 603 provided within the radiation passageway 128. In this way, as shown, water enters the water filtration assembly 600 (as represented by arrows 605), travels through the wall(s) 134 of the filtration media block 114 (as represented by arrows 606), exits the wall(s) 134 of the filtration media block 114 and is directed by the flow barrier(s) 603 towards the electromagnetic radiation emitter 144 (as represented by arrows 608), and is then subsequently directed through the radiation passageway 128 in the middle of the flow barrier 603 (as represented by arrows 610). In such embodiments, the configuration of FIG. 10 improves system efficiency by controlling the flow path of water and ensuring that all treated water receives equal amount of germicidal radiation. Furthermore, in certain embodiments, the internal walls of the flow barrier 603 can be made of and/or coated with reflective material and may serve as a reflective sleeve, such as the reflective sleeve 504 described herein. In still further embodiments, the configuration of FIG. 10 can be used in combination with any one or of all embodiments described herein.

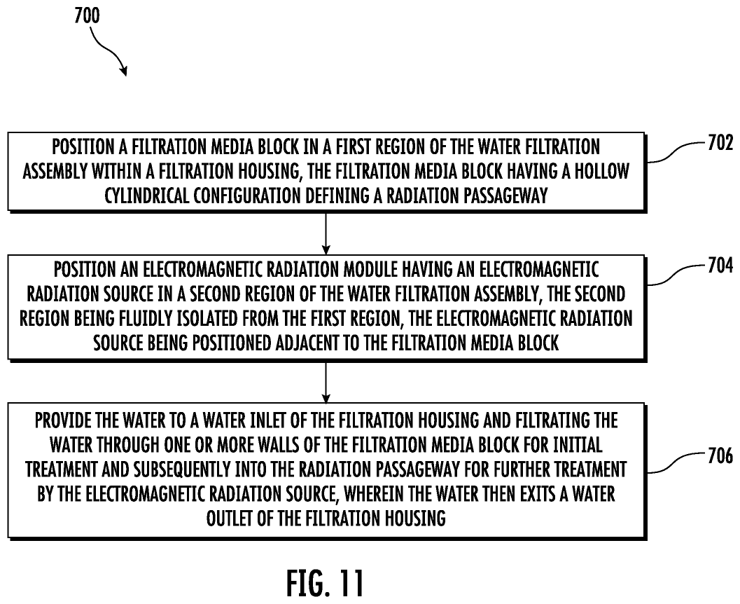

In further embodiments, the present disclosure is directed to a method for treating water using a water filtration assembly according to the present disclosure. Thus, FIG. 11 illustrates a flow diagram of an embodiment of a method 700 for treating water using a water filtration assembly according to the present disclosure. In general, the method 700 is described herein with reference to the water filtration assembly(ies) and the appliance illustrated in FIGS. 4-10. However, it should be appreciated that the disclosed method may be implemented with any water filtration assembly and appliance having any other suitable configurations. In addition, although FIG. 11 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown at (702), the method 700 includes positioning a filtration media block in a first region of the water filtration assembly within a filtration housing. In an embodiment, for example, the water filtration assembly may be any of the embodiments illustrated in FIGS. 4-10. Thus, as previously discussed, the filtration media block has a hollow cylindrical configuration defining a radiation passageway.

As shown at (704), the method 700 includes positioning an electromagnetic radiation module having an electromagnetic radiation source in a second region of the water filtration assembly, the second region being fluidly isolated from the first region. In such embodiments, the electromagnetic radiation source is positioned adjacent to the filtration media block. Accordingly, as shown at (706), the method 700 includes providing the water to a water inlet of the filtration housing and filtrating the water through one or more walls of the filtration media block for initial treatment and subsequently into the radiation passageway for further treatment by the electromagnetic radiation source, wherein the water then exits a water outlet of the filtration housing.

Further aspects of the present disclosure are provided by the subject matter of the following clauses:

A water filtration assembly for an appliance, comprising: a filtration housing; a filtration media block positioned within the filtration housing, the filtration media block having a hollow cylindrical configuration defining a radiation passageway; an electromagnetic radiation module positioned within the filtration housing and having an electromagnetic radiation source positioned adjacent to the filtration media block, wherein water is configured to enter a water inlet of the filtration housing, travel through one or more walls of the filtration media block for treatment and into the radiation passageway for further treatment by the electromagnetic radiation source, and exit a water outlet of the filtration housing.

The water filtration assembly of any preceding clause, wherein the filtration media block comprises at least one of an activated carbon (AC) block, a zeolite, a non-woven and textile block, an immobilized granulated media, an ion exchange resin block, a membrane, a hollow fiber, or a composite block.

The water filtration assembly of any preceding clause, wherein the electromagnetic radiation source is an electromagnetic radiation emitter that emits germicidal radiation via at least one of an ultraviolet-C (UVC) emitting diode, a blue light emitting diode (LED), an ultraviolet-A (UVA) emitting diode, or an ultraviolet-B (UVB) emitting diode.

The water filtration assembly of any preceding clause, further comprising a first end cap secured to a first end of the filtration media block and a second end cap secured to a second end of the filtration media block, the second end cap extending from an inner surface of the filtration housing to divide an inner volume of the filtration housing into a first region and a second region, wherein the electromagnetic radiation module is positioned within the first region and the filtration media block is situated within the second region.

The water filtration assembly of any preceding clause, further comprising a lens arranged adjacent to the electromagnetic radiation emitter such that electromagnetic radiation emitted by the electromagnetic radiation emitter passes through the lens before treating the water in the radiation passageway.

The water filtration assembly of any preceding clause, wherein the lens is configured to fluidly isolate the filtration media block from the electromagnetic radiation module.

The water filtration assembly of any preceding clause, wherein the lens is one of a collimating lens or a converging lens.

The water filtration assembly of any preceding clause, wherein the electromagnetic radiation source is positioned at least partially through the second end cap.

The water filtration assembly of any preceding clause, wherein the electromagnetic radiation source emits germicidal radiation via an ultraviolet-C (UVC) bulb positioned with the radiation passageway.

The water filtration assembly of any preceding clause, wherein the filtration housing comprises a first end and a second end, the first end for securing to a wall of the appliance, the second end receiving at least a portion of the electromagnetic radiation module.

The water filtration assembly of any preceding clause, further comprising a reflective sleeve positioned within the radiation passageway, the reflective sleeve configured to reflect radiation rays.

The water filtration assembly of any preceding clause, wherein the reflective sleeve is constructed of at least one of polytetrafluoroethylene (PTFE) or aluminum.

The water filtration assembly of any preceding clause, further comprising one or more flow barriers arranged within the radiation passageway to direct the water exiting the one or more walls of the filtration media block towards the electromagnetic radiation source and back through a length of the radiation passageway.

The water filtration assembly of any preceding clause, wherein the appliance comprises at least one of a refrigerator appliance, an icemaker appliance, a dishwasher appliance, a water purifier appliance, a beverage system appliance, or washing machine appliance.

A method of treating water using a water filtration assembly, the method comprising: positioning a filtration media block in a first region of the water filtration assembly within a filtration housing, the filtration media block having a hollow cylindrical configuration defining a radiation passageway; positioning an electromagnetic radiation module having an electromagnetic radiation source in a second region of the water filtration assembly, the second region being fluidly isolated from the first region, the electromagnetic radiation source being positioned adjacent to the filtration media block; and providing the water to a water inlet of the filtration housing and filtrating the water through one or more walls of the filtration media block for initial treatment and subsequently into the radiation passageway for further treatment by the electromagnetic radiation source, wherein the water then exits a water outlet of the filtration housing.

The method of any preceding clause, wherein the filtration media block comprises at least one of an activated carbon (AC) block, a zeolite, a non-woven and textile block, an immobilized granulated media, an ion exchange resin block, a membrane, a hollow fiber, or a composite block.

The method of any preceding clause, wherein the electromagnetic radiation source is an electromagnetic radiation emitter that emits germicidal radiation via at least one of an ultraviolet-C (UVC) emitting diode, a blue light emitting diode (LED), an ultraviolet-A (UVA) emitting diode, an ultraviolet-B (UVB) emitting diode, or an ultraviolet-C (UVC) bulb.

The method of any preceding clause, further comprising positioning a lens within the filtration housing such that the lens is arranged adjacent to the electromagnetic radiation source, the lens configured such that electromagnetic radiation emitted by the electromagnetic radiation source passes through the lens before treating the water in the radiation passageway.

The method of any preceding clause, further comprising positioning a reflective sleeve within the radiation passageway, the reflective sleeve configured to reflect radiation rays.

The method of any preceding clause, further comprising arranging one or more flow barriers within the radiation passageway to direct water exiting the one or more walls of the filtration media block towards the electromagnetic radiation source and back through a length of the radiation passageway.

This written description uses examples to disclose the present disclosure, including the best mode, and also to enable any person skilled in the art to practice the present disclosure, including making and using any devices or systems and performing any incorporated methods. The patentable scope of the present disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water filtration assembly for an appliance, comprising:
a filtration housing;
a filtration media block positioned within the filtration housing, the filtration media block having a hollow cylindrical configuration defining a radiation passageway;
an electromagnetic radiation module positioned within the filtration housing and having an electromagnetic radiation source positioned adjacent to the filtration media block,
wherein water is configured to enter a water inlet of the filtration housing, travel through one or more walls of the filtration media block for treatment and into the radiation passageway for further treatment by the electromagnetic radiation source, and exit a water outlet of the filtration housing.

2. The water filtration assembly of claim 1, wherein the filtration media block comprises at least one of an activated carbon (AC) block, a zeolite, a non-woven and textile block, an immobilized granulated media, an ion exchange resin block, a membrane, a hollow fiber, or a composite block.

3. The water filtration assembly of claim 1, wherein the electromagnetic radiation source is an electromagnetic radiation emitter that emits germicidal radiation via at least one of an ultraviolet-C (UVC) emitting diode, a blue light emitting diode (LED), an ultraviolet-A (UVA) emitting diode, or an ultraviolet-B (UVB) emitting diode.

4. The water filtration assembly of claim 1, further comprising a first end cap secured to a first end of the filtration media block and a second end cap secured to a second end of the filtration media block, the second end cap extending from an inner surface of the filtration housing to divide an inner volume of the filtration housing into a first region and a second region, wherein the electromagnetic radiation module is positioned within the first region and the filtration media block is situated within the second region.

5. The water filtration assembly of claim 4, further comprising a lens arranged adjacent to the electromagnetic radiation emitter such that electromagnetic radiation emitted by the electromagnetic radiation emitter passes through the lens before treating the water in the radiation passageway.

6. The water filtration assembly of claim 5, wherein the lens is configured to fluidly isolate the filtration media block from the electromagnetic radiation module.

7. The water filtration assembly of claim 5, wherein the lens is one of a collimating lens or a converging lens.

8. The water filtration assembly of claim 4, wherein the electromagnetic radiation source is positioned at least partially through the second end cap.

9. The water filtration assembly of claim 1, wherein the electromagnetic radiation source emits germicidal radiation via an ultraviolet-C (UVC) bulb positioned with the radiation passageway.

10. The water filtration assembly of claim 1, wherein the filtration housing comprises a first end and a second end, the first end for securing to a wall of the appliance, the second end receiving at least a portion of the electromagnetic radiation module.

11. The water filtration assembly of claim 1, further comprising a reflective sleeve positioned within the radiation passageway, the reflective sleeve configured to reflect radiation rays.

12. The water filtration assembly of claim 11, wherein the reflective sleeve is constructed of at least one of polytetrafluoroethylene (PTFE) or aluminum.

13. The water filtration assembly of claim 1, further comprising one or more flow barriers arranged within the radiation passageway to direct the water exiting the one or more walls of the filtration media block towards the electromagnetic radiation source and back through a length of the radiation passageway.

14. The water filtration assembly of claim 1, wherein the appliance comprises at least one of a refrigerator appliance, an icemaker appliance, a dishwasher appliance, a water purifier appliance, a beverage system appliance, or washing machine appliance.

15. A method of treating water using a water filtration assembly, the method comprising:
positioning a filtration media block in a first region of the water filtration assembly within a filtration housing, the filtration media block having a hollow cylindrical configuration defining a radiation passageway;
positioning an electromagnetic radiation module having an electromagnetic radiation source in a second region of the water filtration assembly, the second region being fluidly isolated from the first region, the electromagnetic radiation source being positioned adjacent to the filtration media block; and
providing the water to a water inlet of the filtration housing and filtrating the water through one or more walls of the filtration media block for initial treatment and subsequently into the radiation passageway for further treatment by the electromagnetic radiation source, wherein the water then exits a water outlet of the filtration housing.

16. The method of claim 15, wherein the filtration media block comprises at least one of an activated carbon (AC) block, a zeolite, a non-woven and textile block, an immobilized granulated media, an ion exchange resin block, a membrane, a hollow fiber, or a composite block.

17. The method of claim 15, wherein the electromagnetic radiation source is an electromagnetic radiation emitter that emits germicidal radiation via at least one of an ultraviolet-C (UVC) emitting diode, a blue light emitting diode (LED), an ultraviolet-A (UVA) emitting diode, an ultraviolet-B (UVB) emitting diode, or an ultraviolet-C (UVC) bulb.

18. The method of claim 15, further comprising positioning a lens within the filtration housing such that the lens is arranged adjacent to the electromagnetic radiation source, the lens configured such that electromagnetic radiation emitted by the electromagnetic radiation source passes through the lens before treating the water in the radiation passageway.

19. The method of claim 15, further comprising positioning a reflective sleeve within the radiation passageway, the reflective sleeve configured to reflect radiation rays.

20. The method of claim 15, further comprising arranging one or more flow barriers within the radiation passageway to direct water exiting the one or more walls of the filtration media block towards the electromagnetic radiation source and back through a length of the radiation passageway.
